(19) United States
(12) Patent Application Publication
(10) Pub. No.: US 2026/0193058 A1
(43) Pub. Date: Jul. 9, 2026

(54) STAIRLIFT SYSTEM

(71) Applicant: Deborah Brannaka, Carmel, IN (US)

(72) Inventor: Deborah Brannaka, Carmel, IN (US)

(21) Appl. No.: 19/015,021

(22) Filed: Jan. 9, 2025

(51) Int. Cl. B66B 9/08; E04F 11/18

(52) U.S. Cl. CPC B66B 9/083; B66B 9/0853; E04F 11/1802

(57) ABSTRACT

A stairlift system for moving a standing user over a flight of stairs includes a guide track, a carriage mounted on the guide track, and a drive mechanism for moving the carriage along the guide track. The carriage extends through a slot on a body of the guide track and includes a platform configured for an individual to stand atop during use. The drive mechanism is mounted in the guide track and is operatively coupled to the carriage.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to stairlifts and more particularly pertains to a new stairlift for moving a standing user over a flight of stairs.

### (2) Description of Related Art Including Information Disclosed Under 37 CFR 1.97 and 1.98.

The prior art describes myriad stairlifts which are often directed toward users using wheelchairs or which need to be in a seated position to operate the stairlifts. Many of these stairlifts also have tracks or other components which rest atop the stairs of a staircase, which may create interferences between the device and certain staircases. The prior art fails, however, to describe such an apparatus in which a standing platform is provided such that the user may be in a standing position while balancing by grasping a handrail. The prior art further fails to describe such an apparatus in which the device is entirely supported by a support wall rather than relying on stairs to hold up the device.

### (H) BRIEF SUMMARY OF THE INVENTION

An embodiment of the disclosure meets the needs presented above by generally comprising a guide track, a carriage mounted on the guide track, and a drive mechanism for moving the carriage along the guide track. The guide track comprises a body which is elongated between a first end and a second end and has a front side and a back side which each extend between the first end and the second end. The body defines an interior space therein and defines a slot which extends through the front side of the body to the interior space. The slot is elongated between the first end and the second end of the body. The carriage extends through the slot of the body and is movable between the first end and the second end of the body of the guide track. The carriage also comprises a platform positioned outside the guide track which has an upper surface that faces upwardly with respect to the body of the guide track.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front in-use view of a stairlift system according to an embodiment of the disclosure.

FIG. 2 is a side view of an embodiment of the disclosure.

FIG. 3 is a detail view of a carriage of an embodiment of the disclosure.

### (J) DETAILED DESCRIPTION OF THE INVENTION

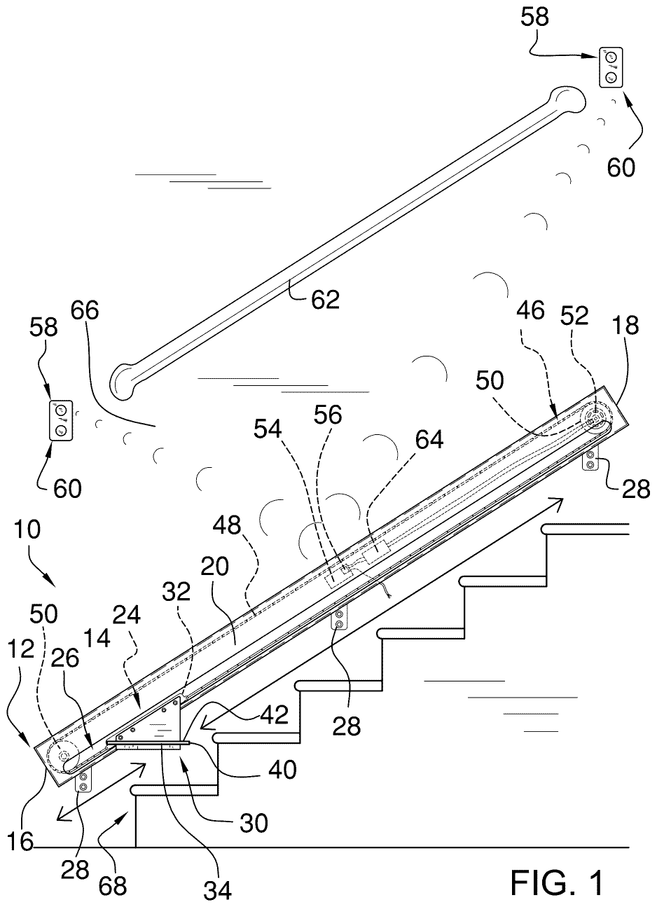

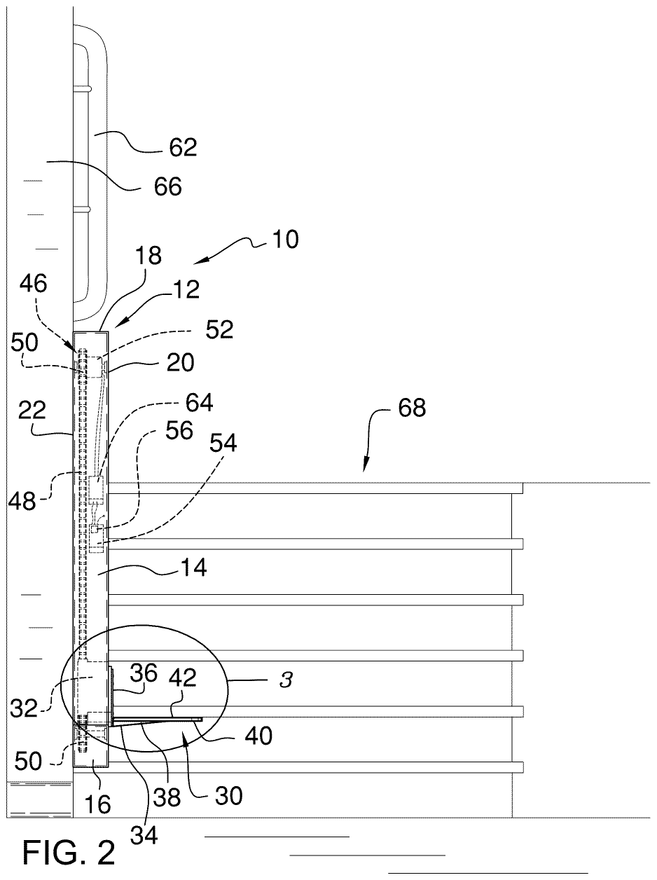

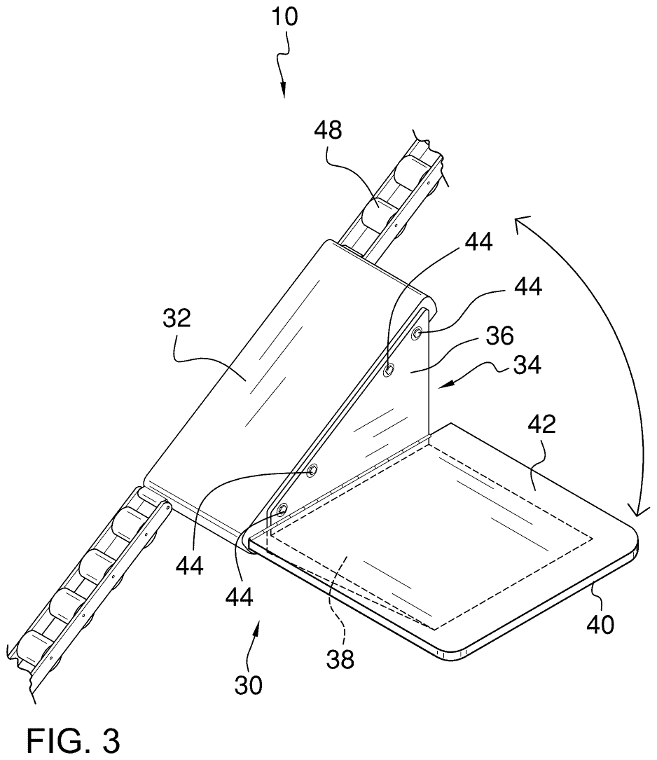

With reference now to the drawings, and in particular to FIGS. 1 through 3 thereof, a new stairlift embodying the principles and concepts of an embodiment of the disclosure and generally designated by the reference numeral 10 will be described.

As best illustrated in FIGS. 1 through 3, the stairlift system 10 generally comprises a guide track 12, a carriage 30 mounted on the guide track 12, and a drive mechanism 46 for driving the carriage 30 along the guide track 12. The guide track 12 comprises a body 14 which is elongated between a first end 16 and a second end 18 and has a front side 20 and a back side 22 which each extend between the first end 16 and the second end 18. The body 14 defines an interior space 24 therein and a slot 26 which extends through the front side 20 of the body 14 to the interior space 24. The slot 26 is elongated between the first end 16 and the second end 18 of the body 14. The guide track 12 also includes mounting brackets 28 which are attached to the back side 22 of the body 14 and have holes to receive threaded fasteners, nails, or other suitable fasteners. The body 14 may be mounted to a support wall 66 via the mounting brackets 28 such that the front side 20 of the body 14 faces away from the support wall 66. In other embodiments, the body 14 may define mounting holes in the back side 22 thereof or may be attached to the support wall 66 via an adhesive or other suitable fastener.

The carriage 30 comprises a skid plate 32, a bracket 34, and a platform 40. The skid plate 32 extends through the slot 26 of the body 14 of the guide track 12 and is movable along the slot 26 via the drive mechanism 46. The bracket 34 has an L-shape with an upright portion 36 attached to the skid plate 32 and an extension portion 38 attached to the platform 40. The upright portion 36 extends downwardly from the skid plate 32 with respect to the guide track 12, and the extension portion 38 extends away from the upright portion 36 forwardly with respect to the guide track 12. The platform 40 is positioned on the extension portion 38 of the bracket 34 and has an upper surface 42 which faces upwardly with respect to the body 14 of the guide track 12. The platform 40 defines an acute angle with a central longitudinal axis of the body 14 of the guide track 12. The upper surface 42 of the platform 40 is frictionally enhanced such as by comprising rubber, silicone, or like material or being textured. The platform 40 is pivotable upwardly toward the guide track 12 to fold the platform 40 up out of the way when not in use.

The bracket 34 is removably attached to the skid plate 32 via a plurality of bolts 44. Other removable fasteners may be used such as latches, hook members, magnets, or the like. In some embodiments, the bracket 34 may be integrally formed with the skid plate 32.

The drive mechanism 46 comprises a roller chain 48, a pair of pulleys 50, and a motor 52. The motor 52 is operatively coupled to one of the pulleys 50. The pulleys 50 are spaced apart from each other on opposite ends of the guide track 12, and the roller chain 48 is mounted on the pulleys 50. The roller chain 48 is also attached to and forms a closed loop with the skid plate 32 of the carriage 30. The pulleys 50 may have sprocket teeth to engage the roller chain 48. In other embodiments, other flexible members such as belts, cables, ropes, or the like may be used instead of or in addition to the roller chain 48. In other embodiments, the drive mechanism 46 may comprise linear actuators, power screws, or other suitable devices.

A processor 54 is operatively coupled to the motor 52 of the drive mechanism 46 via a motor controller 64. In some embodiments, the motor controller 64 may be integrated with the processor 54. A transceiver 56 is operatively coupled to the processor 54, and each one of a pair of controllers 58 is operatively coupled to the processor via wireless communication with the transceiver 56. Each controller 58 includes a control interface 60 configured for controlling the processor 54. In some embodiments, the controllers 58 may be operably coupled to the processor 54 via wires.

A handrail 62 is spaced away from the guide track 12. The handrail 62 is elongated and extends parallel to the body 14 of the guide track 12. The handrail 62 is configured to be mounted to the support wall 66 such as by defining holes for receiving mounting fasteners therethrough. The guide track 12 and the handrail 62 are supported entirely by the support wall 66 during use rather than resting atop stairs. The controllers 58 are configured to be mounted to the support wall 66 opposite each other across the handrail 62.

In use, the guide track 12 is mounted to the support wall 66 over a flight of stairs 68. A user steps onto the platform 40 and operates the motor 52 via the controllers 58 to move alternately up or down the flight of stairs 68. While on the platform 40, the user may use the handrail 62 to stabilize him-or herself. As the carriage 30 moves along the guide track 12, the skid plate 32 rests against a lower interior surface of the slot 26 of the body 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A stairlift system comprising:
a guide track, the guide track comprising a body which is elongated between a first end and a second end, the body having a front side and a back side which each extend between the first end and the second end, the body defining an interior space therein, the body defining a slot which extends through the front side of the body to the interior space, the slot being elongated between the first end and the second end of the body;
a carriage mounted on the guide track, the carriage being movable between the first end and the second end of the body of the guide track, the carriage extending through the slot, the carriage comprising a platform, an upper surface of the platform facing upwardly with respect to the body of the guide track; and
a drive mechanism configured to move the carriage along the guide track.

2. The stairlift system of claim 1, wherein the guide track is configured for being mounted to a support wall such that the front side of the body faces away from the support wall.

3. The stairlift system of claim 1, wherein the carriage further comprises:
a skid plate which extends through the slot of the body of the guide track, the skid plate being movable along the slot; and
a bracket which couples the skid plate to the platform, the bracket having an L-shape with an upright portion and an extension portion, the upright portion being coupled to the skid plate, the extension portion being coupled to the platform, the upright portion extending downwardly from the skid plate with respect to the guide track, the extension portion being coupled to and extending away from the upright portion forwardly with respect to the guide track.

4. The stairlift system of claim 1, wherein the upper surface of the platform defines an acute angle with a central longitudinal axis of the body of the guide track.

5. The stairlift system of claim 1, wherein the upper surface of the platform is frictionally enhanced.

6. The stairlift system of claim 1, wherein the drive mechanism comprises:
a flexible force transmission member, the flexible force transmission member being coupled to and forming a closed loop with the carriage;
a pair of pulleys mounted to the guide track and spaced apart from each other along the guide track, the flexible force transmission member being mounted around each pulley of the pair of pulleys; and
a motor operatively coupled to one pulley of the pair of pulleys;

7. The stairlift system of claim 6, wherein the flexible force transmission member comprises a roller chain.

8. The stairlift system of claim 1, further comprising:
a processor operatively coupled to the drive mechanism;
a transceiver operatively coupled to the processor;
a handrail spaced away from the guide track, the handrail being elongated and extending parallel to the body of the guide track, the handrail being configured to be mounted to the support wall; and
a pair of controllers operatively coupled to the processor, the pair of controllers being configured to be mounted to the support wall opposite each other across the handrail, each controller of the pair of controllers being in wireless communication with the processor via the transceiver.

9. The stairlift system of claim 1, wherein the platform is pivotable upwardly toward the guide track.

10. A stairlift system comprising:
a guide track, the guide track comprising a body which is elongated between a first end and a second end, the body having a front side and a back side which each extend between the first end and the second end, the body defining an interior space therein, the body defining a slot which extends through the front side of the body to the interior space, the slot being elongated between the first end and the second end of the body, the guide track being configured for being mounted to a support wall such that the front side of the body faces away from the support wall;
a carriage mounted on the guide track, the carriage being movable between the first end and the second end of the body of the guide track, the carriage comprising:
a skid plate which extends through the slot of the body of the guide track, the skid plate being movable along the slot;
a bracket coupled to the skid plate, the bracket having an L-shape with an upright portion and an extension portion, the upright portion being coupled to the skid plate, the upright portion extending downwardly from the skid plate with respect to the guide track, the extension portion being coupled to and extending away from the upright portion forwardly with respect to the guide track; and
a platform mounted to the bracket, the platform being positioned on the extension portion, the platform having an upper surface which faces upwardly with respect to the body of the guide track, the platform defining an acute angle with a central longitudinal axis of the body of the guide track, the upper surface of the platform being frictionally enhanced, the platform and the bracket being pivotable upwardly toward the guide track;
a drive mechanism configured to move the carriage along the guide track, the drive mechanism comprising:
a roller chain mounted to the guide track, the roller chain being coupled to and forming a closed loop with the carriage;
a pair of pulleys mounted to the guide track and spaced apart from each other along the guide track, the roller chain being mounted around each pulley of the pair of pulleys; and
a motor operatively coupled to one pulley of the pair of pulleys;
a processor operatively coupled to the motor of the drive mechanism;
a transceiver operatively coupled to the processor;
a pair of controllers operatively coupled to the processor, the pair of controllers being configured to be mounted to the support wall opposite each other across the handrail, each controller of the pair of controllers being in wireless communication with the processor via the transceiver; and
a handrail spaced away from the guide track, the handrail being elongated and extending parallel to the body of the guide track, the handrail being configured to be mounted to the support wall.
